(19) United States
(12) Patent Application Publication
(10) Pub. No.: US 2022/0065385 A1
(43) Pub. Date: Mar. 3, 2022

(54) HEAT-INSULATING SHEET AND METHOD FOR MANUFACTURING SAME

(71) Applicant: Panasonic Intellectual Property Management Co., Ltd., Osaka (JP)

(72) Inventors: KUNXIAN CAO, Hokkaido (JP); RIKAKO IWASAKI, Osaka (JP)

(21) Appl. No.: 17/418,294

(22) PCT Filed: Oct. 16, 2019
(86) PCT No.: PCT/JP2019/040563

§ 371 Date: Jun. 25, 2021

(30) Foreign Application Priority Data
Mar. 8, 2019 (JP) 2019-042107
Mar. 19, 2019 (JP) 2019-050578

(51) Int. Cl. F16L 59/02

(52) U.S. Cl. CPC F16L 59/028; H01M 10/658; F16L 59/026

(57) ABSTRACT

A heat-insulating sheet includes a fiber sheet having spaces therein and silica xerogel held in the spaces. The heat-insulating sheet includes a high-compressive region and a low-compressive region. A compression rate of the high-compressive region of the heat-insulating sheet with respect to a pressure of 0.25 MPa applied to the high-compressive region is greater than or equal to 30% and less than or equal to 50%. A compression rate of the low-compressive region of the heat-insulating sheet with respect to a pressure of 0.25 MPa applied to the low-compressive region is greater than or equal to 1% and less than or equal to 5%. This heat-insulating sheet has large thermal insulation as a whole.

### TECHNICAL FIELD

The present disclosure relates to a heat-insulating sheet for use as heat insulating measures and to a method for manufacturing the sheet.

### BACKGROUND ART

In a lithium-ion battery module for vehicles, plural battery cells are disposed in a housing and fixed under a predetermined pressure in order to obtain vibration resistance. An outer frame may be placed between the battery cells in order to provide insulation between the battery cells. To enhance dimensional accuracy of the module, the outer frame is made of material is hardly compressed. If thermal runaway occurs in one of the battery cells, the thermal runaway affects its adjacent battery cell. A heat-insulating sheet may be placed between the battery cells to block a heat flow to the adjacent battery cell. The heat-insulating sheet may be made of, e.g. silica xerogel.

Conventional heat-insulating sheets similar to the heat-insulating sheet described above are disclosed in, e.g. PTLs 1 and 2.

### CITATION LIST

### Patent Literature

PTL 1: Japanese Patent Laid-Open Publication No. 2016-3159

PTL 2: Japanese Patent Laid-Open Publication No. 2011-136859

### SUMMARY

A heat-insulating sheet includes a fiber sheet having spaces therein and silica xerogel held in the spaces. The heat-insulating sheet includes a high-compressive region and a low-compressive region. A compression rate of the high-compressive region of the heat-insulating sheet with respect to a pressure of 0.25 MPa applied to the high-compressive region is greater than or equal to 30% and less than or equal to 50%. A compression rate of the low-compressive region of the heat-insulating sheet with respect to a pressure of 0.25 MPa applied to the low-compressive region is greater than or equal to 1% and less than or equal to 5%.

Another heat-insulating sheet includes a fiber sheet having spaces therein and silica xerogel held in the spaces. The heat-insulating sheet includes a high-compressive region and a low-compressive region. The high-compressive region is located at a center portion of the heat-insulating sheet.

The low-compressive region surrounds the high-compressive region. A compression rate of the high-compressive region with respect to a pressure of 5 MPa applied to the high-compressive region is larger than a compression rate of the low-compressive region with respect to a pressure of 5 MPa applied to the low-compressive region.

These heat-insulating sheets have large thermal insulation as a whole.

### BRIEF DESCRIPTION OF DRAWINGS

FIG. 1 is a cross-sectional view of a heat-insulating sheet according to Exemplary Embodiment 1.

FIG. 2 is a plan view of the heat-insulating sheet according to Embodiment 1.

FIG. 3 is a cross-sectional view of a battery module including the heat-insulating sheet according to Embodiment 1.

FIG. 4 is an enlarged plan view of the heat-insulating sheet according to Embodiment 1.

FIG. 5 is a cross-sectional view of the heat-insulating sheet according to Embodiment 1 for illustrating a method for manufacturing the heat-insulating sheet.

FIG. 6 is a cross-sectional view of a heat-insulating sheet according to Exemplary Embodiment 2.

FIG. 7 is a plan view of the heat-insulating sheet according to Embodiment 2.

FIG. 8 is a cross-sectional view of a battery module including the heat-insulating sheet according to Embodiment 2.

FIG. 9 is a cross-sectional view of the heat-insulating sheet according to Embodiment 2 for illustrating a method for manufacturing the heat-insulating sheet.

### DETAIL DESCRIPTION OF PREFERRED EMBODIMENTS EXEMPLARY EMBODIMENT 1

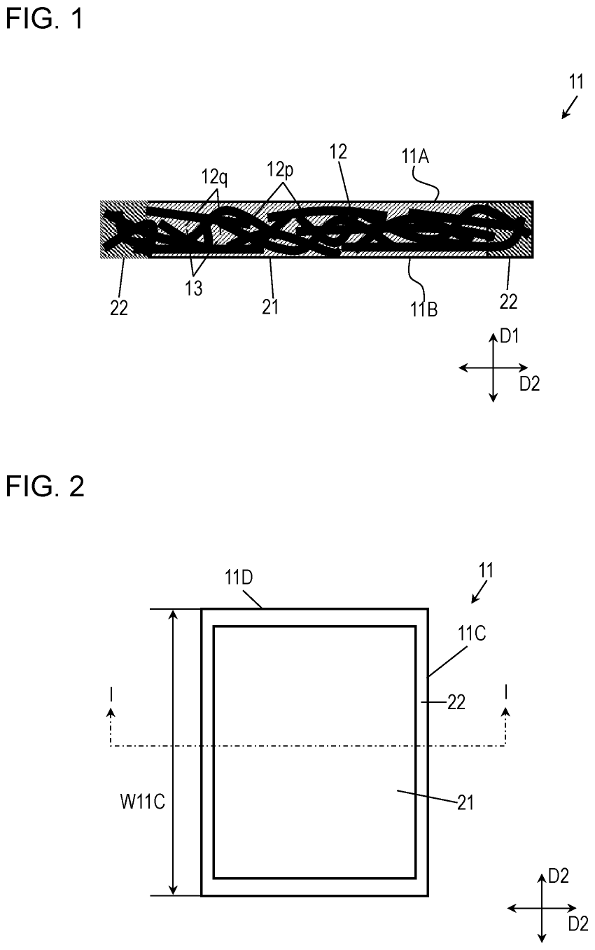

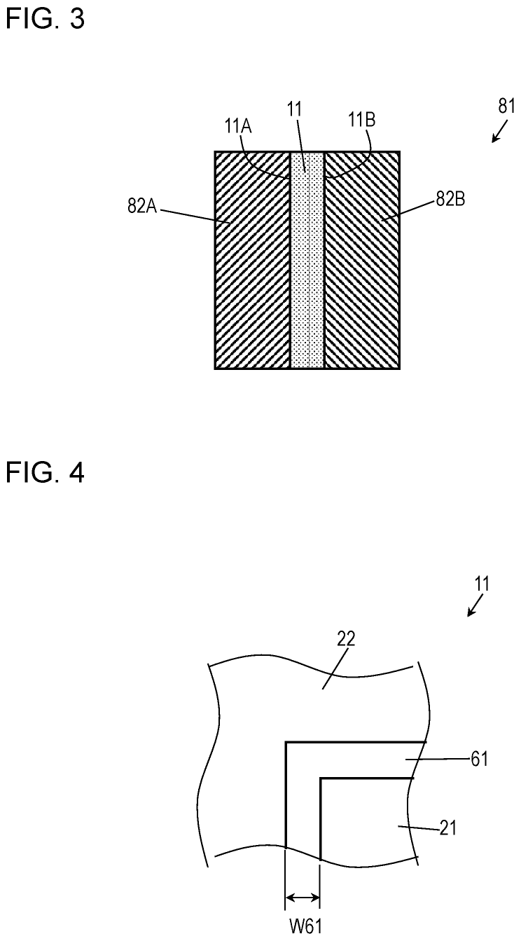

FIGS. 1 and 2 are a cross-sectional view and a plan view of heat-insulating sheet 11 according to exemplary Embodiment 1, respectively. FIG. 1 shows a cross section of heat-insulating sheet 11 along line I-I illustrated in FIG. 2.

Heat-insulating sheet 11 includes fiber sheet 12 having spaces 12q therein and silica xerogel 13 held in spaces 12q of fiber sheet 12. Heat-insulating sheet 11 has two surfaces 11A and 11B opposite to each other, and has a thickness of about 1 mm, which is a distance between surfaces 11A and 11B. Surfaces 11A and 11B are arranged in thickness direction D1. Surfaces 11A and 11B are extended in surface directions D2 perpendicular to thickness direction D1. Each of surfaces 11A and 11B has a rectangular shape having long sides 11C with a length of about 150 mm and short sides 11D with a length of about 100 mm. Fiber sheet 12 is made of fibers 12p that are glass fibers entangled to form spaces 12q between the fibers. The fibers have an average fiber diameter of about 10 μm. A proportion of the sum of the volumes of spaces 12q to the total volume of fiber sheet 12 is about 90%. Spaces 12q in fiber sheet 12 are filled with silica xerogel 13. Silica xerogel 13 has nanosized spaces therein, and thus, portions filled with silica xerogel 13 have a thermal conductivity ranging from 0.020 to 0.060 W/m·K. Silica xerogel 13 is dried xerogel in a broad sense, and may be obtained not only by general drying but also by supercritical drying or freeze-drying, for example.

Heat-insulating sheet 11 is often shaped to be fitted to a place of use, and may have a circular shape or a trapezoidal shape, instead of the rectangular shape.

Heat-insulating sheet 11 typically has a rectangular shape. As illustrated in FIG. 2, heat-insulating sheet 11 includes high-compressive region 21 and low-compressive region 22 surrounding high-compressive region 21. High-compressive region 21 is disposed at a center portion of heat-insulating sheet 11 in surface directions D2 in which surfaces 11A and 11B are extended. Low-compressive region 22 is disposed at a peripheral portion of heat-insulating sheet 11 surrounding the center portion of heat-insulating sheet 11. Low-compressive region 22 is compressed by about 3% under a pressure of 0.25 MPa while high-compressive region 21 is compressed by about 40% under a pressure of 0.25 MPa. That is, a compression rate of low-compressive region 22 with respect to a pressure of 0.25 MPa applied to low-compressive region 22 is about 3%. A compression rate of high-compressive region 21 with respect to a pressure of 0.25 MPa applied to high-compressive region 21 is about 40%.

A compression rate Pn with respect to a given pressure is expressed as Pn=(t0−t1)/t0×100 (%) where t0 is a thickness of heat-insulating sheet 11 in a natural state, i.e., with no pressure applied thereto and t1 is a thickness of heat-insulating sheet 11 with the given pressure applied thereto.

Low-compressive region 22 has a thermal conductivity of about 0.05 W/m·K, and high-compressive region 21 has a thermal conductivity of about 0.02 W/m·K. The size of surface 11A (11B) of high-compressive region 21 is about 140 mm×90 mm.

FIG. 3 is a cross-sectional view of battery module 81 including heat-insulating sheet 1 according to Embodiment 1. Battery module 81 includes battery cells 82A and 82B and heat-insulating sheet 11 disposed between battery cells 82A and 82B. In accordance with Embodiment 1, surfaces 11A and 11B of heat-insulating sheet 11 face battery cells 82A and 82B to directly contact battery cells 82A and 82B, respectively. Surfaces 11A and 11B of heat-insulating sheet 11 may contact battery cells 82A and 82B, respectively, with another layer, such as a bonding layer or a cushioning layer, provided between the sheet and each of the batteries. When battery cells 82A and 82B expand, center portions of battery cells 82A and 82B mainly expand, and thus, a pressure is applied mainly to the center portion of heat-insulating sheet 11. Since high-compressive region 21 is provided at the center portion of heat-insulating sheet 11, high-compressive region 21 of heat-insulating sheet 11 is compressed to absorb the expansion, i.e., an increase of thicknesses of battery cells 82A and 82B, thereby preventing pressurization and thermal runaway of battery cells 82A and 82B. On the other hand, low-compressive region 22 provided at the peripheral portion of heat-insulating sheet 11 maintains the distance between battery cells 82A and 82B, thereby enhancing vibration resistance of battery module 81. The compression rate of low-compressive region 22 with respect to a pressure of 0.25 MPa is preferably greater than or equal to 1% and less than or equal to 5%. The compression rate of low-compressive region 22 is than 1% may degrade thermal insulation property, and allow heat to be easily transmitted through the peripheral portion. On the other hand, the compression rate of low-compressive region 22 exceeding 5% may decrease the vibration resistance. The compression rate of high-compressive region 21 with respect to a pressure of 0.25 MPa is preferably greater than or equal to 30% and less than or equal to 50%. The compression rate of high-compressive region 21 less than 30% may decrease the amount of the absorption of the thicknesses, and cause thermal runaway in battery cells 82A and 82B. On the other hand, the compression rate of high-compressive region 21 exceeding 50% may degrade thermal insulation property.

The conventional heat-insulating sheet described above has a gap between the conventional heat-insulating sheet and the outer frame. The gap allows a heat flow to leak through the gap and reach an adjacent battery cell, accordingly increasing the risk of thermal runaway in this battery cell.

In addition, since the material of the outer frame has poor thermal insulation, the thermal runaway in one battery cell increases the amount of passage of a heat flow, accordingly increasing the risk of thermal runaway in its adjacent battery cell.

In contrast, in heat-insulating sheet 11 according to Embodiment 1, high-compressive region 21 and low-compressive region 22 having different compression properties in the same surface as described above maintains the shape of the module without an outer frame, and maintains thermal insulation with expansion of battery cells 82A and 82B absorbed. Heat-insulating sheet 11 thus prevents leakage of a heat flow from one of battery cells 82A and 82B to the other. The peripheral portion of heat-insulating sheet 11 is made of silica xerogel as well as the center portion, thereby enhancing thermal insulation as a whole.

The proportion of the area of high-compressive region 21 to the area of surface 11A (11B) of heat-insulating sheet 11 is preferably greater than or equal to 30% and less than or equal to 95%. The proportion of the area of high-compressive region 21 less than 30% may decrease thermal insulation property of heat-insulating sheet 11, and decrease performance of absorbing an increase of thicknesses of battery cells 82A and 82B. The proportion of the area of high-compressive region 21 exceeding 95% may cause the width of low-compressive region 22 to be less than or equal to 1 mm, hardly stabilizing the dimension of low-compressive region 22, e.g. as the distance between battery cells 82A and 82B.

FIG. 4 is an enlarged plan view of heat-insulating sheet 11. Heat-insulating sheet 11 further includes boundary region 61 located between high-compressive region 21 and low-compressive region 22 and connected to high-compressive region 21 and low-compressive region 22. High-compressive region 21 and low-compressive region 22 are formed by impregnating two regions of fiber sheet 12 with different sols. The sols permeating through the two regions of fiber sheet 12 are not completely separated from each other, and are mixed at the boundary between the two regions, thereby forming boundary region 61. Thus, the compression rate of boundary region 61 with respect to a pressure of 0.25 MPa applied to boundary region 61 is smaller than the compression rate of high-compressive region 21, and is larger than the compression rate of low-compressive region 22. In accordance with Embodiment 1, the compression rate of boundary region 61 is smaller than 30% and larger than 5%. Both of high-compressive region 21 and low-compressive region 22 reach two surfaces 11A and 11B of heat-insulating sheet 11. In accordance with Embodiment 1, boundary region 61 also reaches surfaces 11A and 11B, but may not reach at least one of surfaces 11A and 11B. Width W61 of boundary region 61 in a direction in which high-compressive region 21 and low-compressive region 22 face each other across boundary region 61 interposed is preferably greater than or equal to 0.5 mm, and less than or equal to 20% of width W11C (see FIG. 2) of long side 11C of the rectangular shape of surfaces 11A and 11B. Width W61 of the boundary region less than 0.5 mm may decrease a shearing force in the thickness direction, and cause a crack in heat-insulating sheet 11 when battery cell 82A (82B) expands. Thermal insulation property of boundary region 61 is smaller than that of high-compressive region 21, and thus, width W61 of boundary region 61 greater than or equal to 20% of width W11C of long side 11C may degrade thermal insulation property of heat-insulating sheet 11 as a whole. Width W61 of boundary region 61 is preferably greater than or equal to 0.5 mm and less than or equal to 20% of a maximum width (e.g., width W11C) of heat-insulating sheet 11.

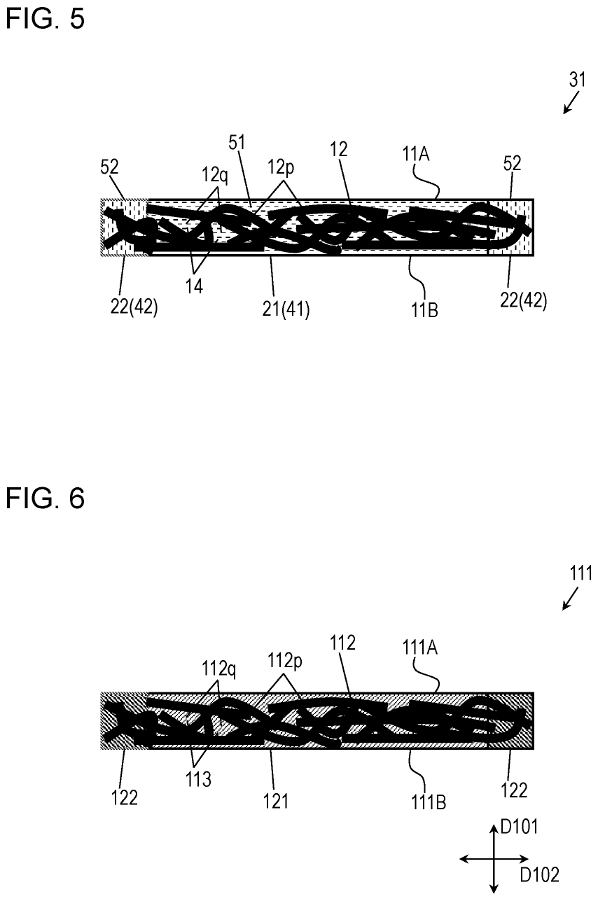

A method for manufacturing heat-insulating sheet 11 according to Embodiment 1 will be described below. FIG. 5 is a cross-sectional view of heat-insulating sheet 11 for illustrating a method for manufacturing heat-insulating sheet 11, and illustrates material sheet 31.

First, fiber sheet 12 made of fibers 12p of glass fibers having a thickness of about 1 mm is prepared.

Next, sol 51 with which high-compressive region 21 is to be impregnated is prepared. Silica sol constituting sol 51 is prepared by adding ethylene carbonate as a catalyst to, e.g. a 6%-water glass solution. Sol 52 with which low-compressive region 22 is to be impregnated is different from sol 51, and is produced by adjusting a silica sol with addition of ethylene carbonate as a catalyst to, e.g. a 20%-water glass solution.

Center region 41 of fiber sheet 12 is impregnated with sol 51. After that, peripheral region 42 surrounding region 41 of fiber sheet 12 is impregnated with sol 52, thereby providing material sheet 31 illustrated in FIG. 5. Material sheet 31 of fiber sheet 12 impregnated with sol 51 and sol 52 is placed in a dryer at about 90° C. for about 10 minutes to allow backbones of silica aerogel of sols 51 and 52 to grow. Material sheet 31 is then immersed in hydrochloric acid, and then, immersed in trisiloxane, thereby forming a hydrophobic group. Subsequently, material sheet 31 is dried at about 150° C. for two hours to vaporize solvent in sol 51 and sol 52, thereby providing heat-insulating sheet 11 illustrated in FIG. 1.

High-compressive region 21 thus formed in region 41 has a compression rate of about 40% with respect to a pressure of 0.25 MPa applied to high-compressive region 21, whereas low-compressive region 22 formed in region 42 has a compression rate of about 3% with respect to a pressure of 0.25 MPa applied to low-compressive region 22.

High-compressive region 21 and low-compressive region 22 may be impregnated with two types of sol 51 and sol 52, respectively, by a screen printing process. First, fiber sheet 12 is covered with a screen printing plate having an opening facing region 41 constituting high-compressive region 21, and then, region 41 of the fiber sheet is impregnated with sol 51 through the opening and dried. Fiber sheet 12 is covered with a screen printing plate having an opening facing region 42 constituting low-compressive region 22, and then, region 42 of fiber sheet 12 is impregnated with sol 52 through the opening and dried, thereby providing material sheet 31. The impregnation with sol 51 and sol may be performed by printing, such as gravure printing and ink jet printing, as well as the screen printing.

### Exemplary Embodiment 2

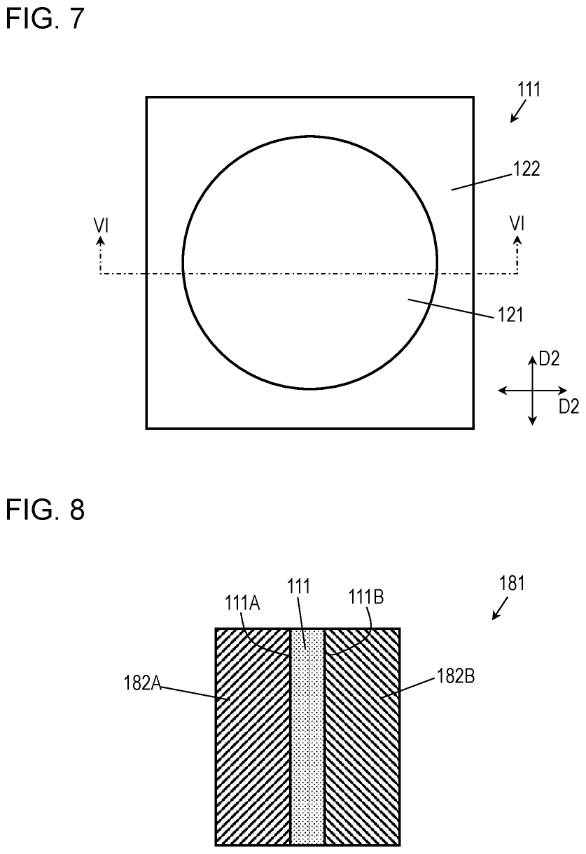

FIGS. 6 and 7 are a cross-sectional view and a plan view of heat-insulating sheet 111 according to Exemplary Embodiment 2, respectively. FIG. 6 shows a cross section of heat-insulating sheet 111 along line VI-VI illustrated in FIG. 7.

Heat-insulating sheet 111 includes fiber sheet 112 having spaces 112q therein and silica xerogel 113 held in spaces 112q of fiber sheet 112. Heat-insulating sheet 111 has two surfaces 111A and 111B opposite to each other. Heat-insulating sheet 111 and has a thickness of about 1 mm, which is a distance between surfaces 111A and 111B. Surfaces 111A and 111B are arranged in thickness direction D101. Surfaces 111A and 111B are extended in surface directions D102 perpendicular to thickness direction D101. Fiber sheet 112 is made of fibers 112p that are glass fibers entangled to form spaces 112q between the fibers. The fibers have an average fiber diameter of about 10 μm. The proportion of the sum of the volumes of spaces 112q to the volume of fiber sheet 112 is about 90%. Spaces 112q in fiber sheet 112 are filled with silica xerogel 113. Silica xerogel 113 has nanosized spaces therein, and thus, portions of the sheet filled with silica xerogel 113 have a thermal conductivity ranging from 0.020 to 0.060 W/m·K. Silica xerogel 113 is dried xerogel in a broad sense, and may be obtained not only by general drying but also by supercritical drying or freeze-drying, for example.

As illustrated in FIG. 7, heat-insulating sheet 111 includes high-compressive region 121 and low-compressive region 122. High-compressive region 121 is disposed at a center portion of the sheet in surface directions D102 in which surfaces 111A and 111B are extended. Low-compressive region 122 surrounds high-compressive region 121. That is, low-compressive region 122 is disposed in a peripheral portion of heat-insulating sheet 111 surrounding the center portion of heat-insulating sheet 111. Low-compressive region 122 is compressed by about 5% with a pressure of 5 MPa applied to low-compressive region 122, and high-compressive region 121 is compressed by about 16% with a pressure of 5 MPa applied to high-compressive region 121. That is, low-compressive region 122 has a compression rate of about 5% with respect to a pressure of 5 MPa applied to low-compressive region 122, and high-compressive region 121 has a compression rate of about 16% with respect to a pressure of 5 MPa applied to high-compressive region 121.

Compression rate Pn with respect to a given pressure is expressed as Pn=(t0−t1)/t0×100 (%) where t0 is a thickness of heat-insulating sheet 111 in a natural state, i.e., with no pressure applied thereto and t1 is a thickness of heat-insulating sheet 11 with the given pressure applied thereto.

Low-compressive region 122 has a thermal conductivity of about 0.05 W/m·K, and high-compressive region 121 has a thermal conductivity of about 0.04 W/m·K. High-compressive region 121 is disposed at a center portion of heat-insulating sheet 111, and has a circular shape or an oval shape having a diameter of about 80 mm.

FIG. 8 is a cross-sectional view of battery module 181 including heat-insulating sheet 111 according to Embodiment 2. Battery module 181 includes battery cells 182A and 182B and heat-insulating sheet 111 disposed between battery cells 182A and 182B. In accordance with Embodiment 2, surfaces 111A and 111B of heat-insulating sheet 111 face battery cells 182A and 182B to directly contact battery cells 182A and 182B, respectively. Surfaces 111A and 111B of heat-insulating sheet 111 may contact battery cells 182A and 182B across another layer, such as a bonding layer or a cushioning layer, provided between the sheet and each cell. When battery cells 182A and 182B expand, center portions of battery cells 182A and 182B mainly expand, and thus, a pressure is applied mainly to the center portion of heat-insulating sheet 111. High-compressive region 121 provided in the center portion of heat-insulating sheet 111 is compressed to absorb expansion, i.e., an increase of thicknesses of battery cells 182A and 182B, thereby preventing pressurization and thermal runaway of battery cells 182A and 182B. On the other hand, low-compressive region 122 provided in the peripheral portion of heat-insulating sheet 111 maintains the distance between battery cells 182A and 182B, thereby enhancing vibration resistance of battery module 181. The compression rate of low-compressive region 122 with respect to a pressure of 5 MPa applied thereto is preferably less than or equal to 7%. The compression rate of low-compressive region 122 exceeding 7% may decrease the vibration resistance. The compression rate of high-compressive region 121 with respect to a pressure of 5 MPa applied thereto is preferably greater than or equal to 10%. The compression rate of high-compressive region 121 less than 10% may decrease the amount of thickness absorption, and may cause thermal runaway of battery cells 182A and 182B.

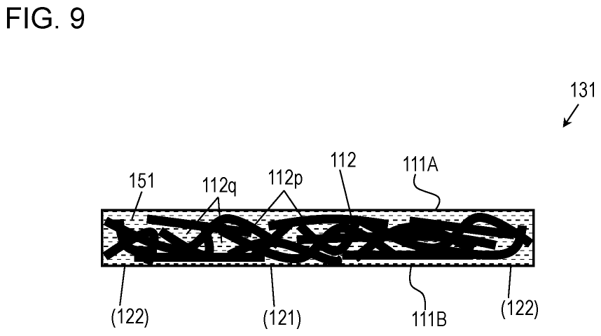

A method for manufacturing heat-insulating sheet 111 according to Embodiment 2 will be described below. FIG. 9 is a cross-sectional view of heat-insulating sheet 111 for illustrating a method for manufacturing heat-insulating sheet 111, and illustrates material sheet 131.

First, fiber sheet 112 having spaces 112q therein is prepared. In accordance with Embodiment 2, fiber sheet 112 has a thickness of about 1 mm, and has a rectangular shape having long sides with a length of about 150 mm and short sides with a length of about 100 mm. In accordance with Embodiment 2, fiber sheet 112 is made of fibers 112p that are glass fibers entangled to form spaces 112q between the fibers. Fibers 112p have an average fiber diameter of about φ2 μm, and a fabric weight of fiber sheet 112 is about 180 g/m².

Next, preparation for impregnating inner space of fiber sheet 112 with silica xerogel 113 is performed. As a material of silica xerogel 113, about 6%-ethylene carbonate as a catalyst is added to about a 20%-water glass raw material, thereby preparing silica sol as sol 151. Fiber sheet 112 is immersed in sol 151 to fill spaces 112q in fiber sheet 112 with sol 151, thereby obtaining material sheet 131 illustrated in FIG. 9.

Then, material sheet 131 impregnated with sol 151 is pressed to have a uniform thickness. The thickness may be uniformized by, e.g. roll pressing. The material sheet with a uniform thickness is sandwiched between films, and sol 151 turns to gel, thereby reinforcing gel backbone.

In allowing sol 151 to turn to gel, only a center portion of fiber sheet 112 of material sheet 131 is heated to about 90° C. for about 10 minutes while a peripheral portion of the fiber sheet is at a room temperature. In the case of adding ethylene carbonate as a catalyst to a water glass raw material, when the temperature exceeds 85° C., hydrolysis rapidly progresses, and gelation proceeds while a part of silica elutes to a peripheral portion. Accordingly, the content of silica xerogel 113 decreases in the high-temperature center portion so that compression rate with respect to an applied pressure increases. Since the peripheral portion has a low temperature, dehydration condensation progresses and gelation of sol 151 continues so that compression rate decreases.

Thereafter, silica xerogel 113 is hydrophobized in the following manner. Fiber sheet 112 impregnated with silica xerogel 113 is immersed in 6N-hydrochloric acid for about 30 minutes, and gel and hydrochloric acid react with each other. Subsequently, fiber sheet 112 impregnated with silica xerogel 113 is immersed in silylating solution of mixture solution of silylating agent and alcohol, and then is stored for about 2 hours in a thermostat at about 55° C. At this moment, the mixture solution of silylating agent and alcohol permeates fiber sheet 112 impregnated with silica xerogel 113. When silylating reaction progresses and formation of trimethyl siloxane bonding starts, hydrochloric acid solution is discharged to the outside of fiber sheet 112 containing silica xerogel 113. After the silylating process has been finished, fiber sheet 112 impregnated with silica xerogel 113 is dried for about two hours in a thermostat at about 150° C., thereby obtaining heat-insulating sheet 111.

In thus-obtained heat-insulating sheet 111, the center portion thereof left at a high temperature includes high-compressive region 121 having a compression rate of about 16% with respect to a pressure of 5 MPa applied to high-compressive region 121, and the peripheral portion includes low-compressive region 122 having compression rate of about 5% with respect to a pressure of 5 MPa applied to low-compressive region 122. In battery module 181 illustrated in FIG. 8, heat-insulating sheet 111 is disposed between battery cells 182A and 182B. For example, even when one battery cell 182A generates heat so that the center portion of the cell expands and the volume increases, the increased volume is absorbed in high-compressive region 121, and the distance between battery cells 182A and 182B is maintained in low-compressive region 122 and thermal insulation is kept. This configuration prevents thermal runaway of battery cells 182A and 182B under the influence on adjacent battery cell 182B. The compression rate of low-compressive region 122 is preferably less than or equal to 7%. The compression rate of low-compressive region 122 exceeding 7% may decrease vibration resistance of battery module 181. The compression rate of high-compressive region 121 is preferably greater than or equal to 10%. The compression rate of high-compressive region 121 less than 10% may decrease the amount of thickness absorption, and cause thermal runaway of battery cells 182A and 182B.

In the conventional heat-insulating sheet described above, a gap is produced between the heat-insulating sheet and the outer frame, and may increase the risk of thermal runaway of adjacent battery cells caused by leakage of a heat flow through the gap. In addition, the material for the outer frame having poor thermal insulation may increase the amount of passage of a heat flow at thermal runaway of one battery cell so that the risk of thermal runaway of its adjacent battery cells increases.

Heat-insulating sheet 111 according to Embodiment 2 maintains the surface of the module without an outer frame, and maintains thermal insulation while expansion of battery cells 182A and 182B is absorbed. Thus, thermal runaway of battery cells 182A and 182B is prevented as described above.

In order to cause the temperature to be different between the center portion and the peripheral portion, fiber sheet 112 impregnated with sol 151 may be placed on a hot plate with a high temperature only in a region of material sheet 131 constituting high-compressive region 121 and partially heated. Alternatively, the region of material sheet 131 constituting high-compressive region 121 may be partially heated by applying infrared rays only to the region constituting high-compressive region 121 or by causing a heating plate having a predetermined shape to the region of fiber sheet 112 impregnated with silica sol.

As described above, sol 151 gels to reinforce its backbone by providing a temperature difference equal to or larger than 50° C. between the center portion and the peripheral portion. Accordingly, a compression rates is significantly different between high-compressive region 121 of the center portion and low-compressive region 122 of the peripheral portion.

The temperature of the center portion is preferably higher than or equal to 85° C. and lower than or equal to 135° C. The temperature lower than 85° C. hardly progresses hydrolysis reaction, whereas the temperature exceeding 135° C. excessively progresses the reaction and accordingly tends to increase variations.

### REFERENCE MARKS IN THE DRAWINGS

11 heat-insulating sheet
12 fiber sheet
13 silica xerogel
21 high-compressive region
22 low-compressive region
31 material sheet
111 heat-insulating sheet
112 fiber sheet
113 silica xerogel
121 high-compressive region
122 low-compressive region
131 material sheet

1. A heat-insulating sheet comprising:
a fiber sheet having spaces therein; and
silica xerogel held in the spaces, wherein
the heat-insulating sheet includes a high-compressive region and a low-compressive region,
a compression rate of the high-compressive region of the heat-insulating sheet with respect to a pressure of 0.25 MPa applied to the high-compressive region is greater than or equal to 30% and less than or equal to 50%, and
a compression rate of the low-compressive region of the heat-insulating sheet with respect to a pressure of 0.25 MPa applied to the low-compressive region is greater than or equal to 1% and less than or equal to 5%.

2. The heat-insulating sheet of claim 1, wherein the high-compressive region is surrounded by the low-compressive region.

3. The heat-insulating sheet of claim 1, wherein a proportion of the high-compressive region to the heat-insulating sheet is greater than or equal to 30% and less than or equal to 95%.

4. The heat-insulating sheet of claim 1, wherein
the heat-insulating sheet further includes a boundary region located between the high-compressive region and the low-compressive region and connected to the high-compressive region and the low-compressive region,
a compression rate of the boundary region with respect to a pressure of 0.25 MPa applied to the boundary region is smaller than the compression rate of the high-compressive region and larger than the compression rate of the low-compressive region,
the heat-insulating sheet has two surfaces opposite to each other, each of the two surfaces having a rectangular shape with long sides and short sides,
both of the high-compressive region and the low-compressive region reach the two surfaces, and
a width of the boundary region is greater than or equal to 0.5 mm and less than or equal to 20% of a length of the long sides of the rectangular shape of the heat-insulating sheet.

5. The heat-insulating sheet of claim 4, wherein the compression rate of the boundary region is smaller than 30% and larger than 5%.

6. The heat-insulating sheet of claim 1, wherein
the heat-insulating sheet further includes a boundary region located between the high-compressive region and the low-compressive region and connected to the high-compressive region and the low-compressive region,
a compression rate of the boundary region with respect to a pressure of 0.25 MPa applied to the boundary region is smaller than the compression rate of the high-compressive region,
the heat-insulating sheet has two surfaces opposite to each other,
both of the high-compressive region and the low-compressive region reach the two surfaces, and
a width of the boundary region is width greater than or equal to 0.5 mm and less than or equal to 20% of a maximum width of the heat-insulating sheet.

7. The heat-insulating sheet of claim 6, wherein the compression rate of the boundary region is smaller than 30% and larger than 5%.

8. A method for manufacturing a heat-insulating sheet, comprising:
preparing a fiber sheet having spaces therein;
impregnating a first region of the fiber sheet with a first sol;
impregnating a second region of the fiber sheet with a second sol different from the first sol;
forming first silica gel in the first region by causing the first sol with which the first region is impregnated to gel;
forming second silica gel in the second region by causing the second sol with which the second region is impregnated to gel;
hydrophobizing the first silica gel;
hydrophobizing the second silica gel; and
drying the hydrophobized first silica gel and the hydrophobized second silica gel, wherein after said drying of the hydrophobized first silica gel and the hydrophobized second silica gel, a compression rate of the first region with respect to a pressure of 0.25 MPa applied to the first region is greater than or equal to 30% and less than or equal to 50%, and a compression rate of the second region with respect to a pressure of 0.25 MPa applied to the second region is greater than or equal to 1% and less than or equal to 5%.

9. The method of claim 8, wherein said impregnating the first region with the first sol comprises impregnating the first region of the fiber sheet with the first sol by ink jet printing or screen printing.

10. The method of claim 8, wherein said impregnating the second region with the second sol comprises impregnating the second region of the fiber sheet with the second sol by ink jet printing or screen printing.

11. A heat-insulating sheet comprising:
a fiber sheet having spaces therein; and
silica xerogel held in the spaces, wherein
the heat-insulating sheet includes a high-compressive region and a low-compressive region, the high-compressive region being located in a center portion of the heat-insulating sheet, the low-compressive region surrounding the high-compressive region, and
a compression rate of the high-compressive region with respect to a pressure of 5 MPa applied to the high-compressive region is larger than a compression rate of the low-compressive region with respect to a pressure of 5 MPa applied to the low-compressive region.

12. The heat-insulating sheet of claim 11, wherein
the compression rate of the high-compressive region is greater than or equal to 10%, and
the compression rate of the low-compressive region is less than or equal to 7%.

13. A method for manufacturing a heat-insulating sheet, comprising:
preparing a fiber sheet having spaces therein;
forming a material sheet by impregnating the spaces of the fiber sheet with a silica sol containing water glass and ethylene carbonate;
forming silica gel by causing the silica sol with which the spaces is impregnated to gel while a temperature of a center portion of the material sheet is higher than a temperature of a peripheral portion of the material sheet surrounding the center portion of the material sheet by a difference equal to or larger than 50° C.; and
hydrophobizing the silica gel, wherein
a compression rate of a center portion of the heat-insulating sheet located in the center portion of the material sheet with respect to a pressure of 5 MPa applied to the center portion of the heat-insulating sheet is larger than a compression rate of a peripheral portion of the heat-insulating sheet surrounding the center portion of the heat-insulating sheet with respect to a pressure of 5 MPa applied to the peripheral portion of the heat-insulating sheet.

14. The method of claim 13, wherein
the compression rate of the center portion of the heat-insulating sheet is greater than or equal to 10%, and
the compression rate of the peripheral portion of the heat-insulating sheet is less than or equal to 7%.

15. The method of claim 13, wherein said forming the silica gel comprises forming the silica gel by causing the silica sol with which the space is impregnated to gel while the temperature of the center portion of the material sheet is higher than the temperature of the peripheral portion of the material sheet by the difference equal to or larger than 50° C. and the temperature of the center portion of the material sheet is higher than or equal to 85° C. and lower than or equal to 135° C.
